(19) United States
(12) Patent Application Publication
(10) Pub. No.: US 2014/0345696 A1
(43) Pub. Date: Nov. 27, 2014

(54) ATMOSPHERIC CIRCULATION SYSTEM AND METHOD

(71) Applicant: Jayden HARMAN, (US)

(72) Inventor: Jayden Harman, San Rafael, CA (US)

(21) Appl. No.: 14/357,532

(22) PCT Filed: Nov. 6, 2012
(86) PCT No.: PCT/US12/00544

§ 371 Date: May 9, 2014

Related U.S. Application Data
(60) Provisional application No. 61/629,033, filed on Nov. 9, 2011.

(51) Int. Cl. A01G 15/00; F15D 1/08

(52) U.S. Cl. CPC A01G 15/00; F15D 1/08
USPC 137/1; 137/810

(57) ABSTRACT

An artificially created atmospheric circulation system comprising a plurality of vortex generating units (10), wherein each vortex generating unit (10) is configured to generate an upwardly directed vortex 15 within the atmosphere and wherein the plurality of vortex generating units are configured and associated so that all of the vortices 15 produced combine to provide a single atmospheric vortex (17).

### CROSS-REFERENCE TO RELATED APPLICATIONS

The present application is a national phase application of PCT application PCT/US2012/000544 filed No. 6, 2012, which claims the priority benefit of U.S. provisional application 61/629,033 filed Nov. 9, 2011 the disclosure of which is incorporated herein by reference.

### BACKGROUND OF THE INVENTION

1. Field of the Invention

The present invention relates to the field of fluid mechanics and more particularly to the circulation of atmospheric gases. More particularly, this invention seeks to provide an artificially generated system of circulation within the atmosphere.

2. Description of the Related Art

There are many applications wherein it is desirable to enhance circulation within the atmosphere. Common reasons for providing circulation are for mixing, to prevent stratification and to cause rain precipitation. In addition, it has now been realized that circulation may be used to reduce atmospheric temperature in a controlled manner. Examples of these will be discussed later within this specification.

Few, industrial methods have been devised to cause the desired atmospheric circulation. In nature, however, we see many examples such as tornados, hurricanes, waterspouts, dust devils and the like. All of these cyclic motions act as atmospheric circulators.

The most significant prior art is that of Louis Marc MICHAUD. His disclosure in U.S. Pat. No. 7,086,823 provides a detailed review of the prior art including certain publications made by him explaining the thermodynamics that are involved. A further disclosure by him in WO 2008/014596 describes certain improvements to his invention. These disclosures are hereby incorporated by reference.

The difficulty with Michaud's proposal is that his facility is extremely large and expensive. While the facility promises several advantages, including more efficient cooling towers, low cost operation of wind turbines, as well as possible atmospheric circulation advantages, it is not entirely clear what is the primary purpose, or whether the system would perform any of the tasks effectively. The large area of land that would be required to put the system in to effect would make it impractical near cities where the atmospheric circulation may be of the greatest importance.

### SUMMARY OF THE PRESENTLY CLAIMED INVENTION

According to a first aspect, the invention resides in an artificially created atmospheric circulation system comprising a plurality of vortex generating units, wherein each vortex generating unit is configured to generate an upwardly directed vortex within the atmosphere and wherein the plurality of vortex generating units are configured and associated so that all of the vortices produced combine to provide a single atmospheric vortex.

According to a preferred embodiment, each vortex generating unit comprises a jet emitting means and a nozzle, the jet emitting means being adapted to accelerate atmospheric gas into a gas jet and the nozzle being adapted to cause rotation of the gas jet relative to the axis of the nozzle.

According to a preferred feature of the invention, the jet emitting means and nozzle are supported by a support stand at a suitable distance above the surface of the ground to enable air to be drawn into the jet emitting means without significant impairment and the output of the nozzle is directed substantially vertically.

According to a preferred embodiment, the jet emitting means comprises a jet engine suitable for an aircraft.

According to a preferred embodiment, the jet emitting means is fuelled substantially by hydrogen so that the combustion products promote the formation of precipitation.

According to a preferred embodiment, each vortex generating unit comprises a fan driven by a motor, wherein the fan is configured to generate an atmospheric vortex.

According to a preferred embodiment, each vortex generating unit comprises a duct through which gas is passed and ejected at an outlet, the duct having an insert proximate the outlet, wherein the insert has one or more vanes having a spiralling-helical form of varied pitch to accelerate airflow flow through it into a vortical-like motion to thereby generate an atmospheric vortex.

According to a further aspect, the invention resides in a method of disrupting an inversion layer in the atmosphere by use of an atmospheric circulation system as previously described.

According to a further aspect, the invention resides in a method of causing the precipitation of rain by the use of an atmospheric circulation system as previously described.

According to a further aspect, the invention resides in a method of causing the abatement of tornados or storms by the use of an atmospheric circulation system as previously described.

According to a further aspect, the invention resides in a method for deflecting the course of a hurricane, cyclone, typhoon or the like by the use of an atmospheric circulation system as previously described.

According to a further aspect, the invention resides in a method of expelling heat from the lower atmosphere of the earth by use of an atmospheric circulation system as previously described.

The invention will be more fully understood in the light of the following description of several specific embodiments.

### BRIEF DESCRIPTION OF THE DRAWINGS

The description is made with reference to the accompanying drawings, of which:

FIG. 1 is an isometric view of an elemental vortex generating unit according to a first embodiment;

FIG. 2 is an isometric view of the vortex generating unit of FIG. 1;

FIG. 3 is a diagrammatic representation of the interaction of the flow streams from a plurality of vortex generating units of FIG. 1;

FIG. 4 is a plan view of the arrangement of an array of vortex generating units according to FIG. 1 into a cluster along an equiangular logarithmic spiral;

FIG. 5 is a diagrammatic representation of the interaction of the flow streams from a plurality of vortex generating clusters according to a second embodiment;

FIG. 6 is diagrammatic indication of the flow characteristics of a cluster of vortex as shown in FIG. 5 streams after they have combined;

FIG. 7 is an isometric sectional view of an elemental vortex generating unit according to a fourth embodiment;

FIG. 8 is a sectional view of a pulse nozzle according to a fifth embodiment;

FIG. 9 is a diagrammatic representation of the vortex flow stream generated in the atmosphere in accordance with the invention that would be effective at disturbing an inversion layer;

FIG. 10 is a diagrammatic representation of the vortex flow stream generated in the atmosphere in accordance with the invention that would be effective at causing precipitation;

FIG. 11 is a diagrammatic representation of the vortex flow stream generated in the atmosphere in accordance with the invention that would be effective at expelling heat from the lower atmosphere; and

FIG. 12 is an isometric view of the arrangement of an array of vortex generating units according to FIG. 4.

### DETAILED DESCRIPTION

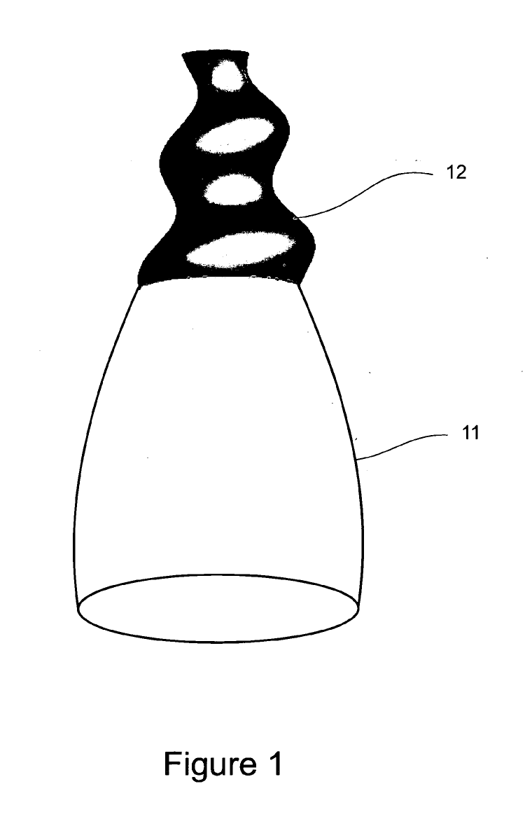

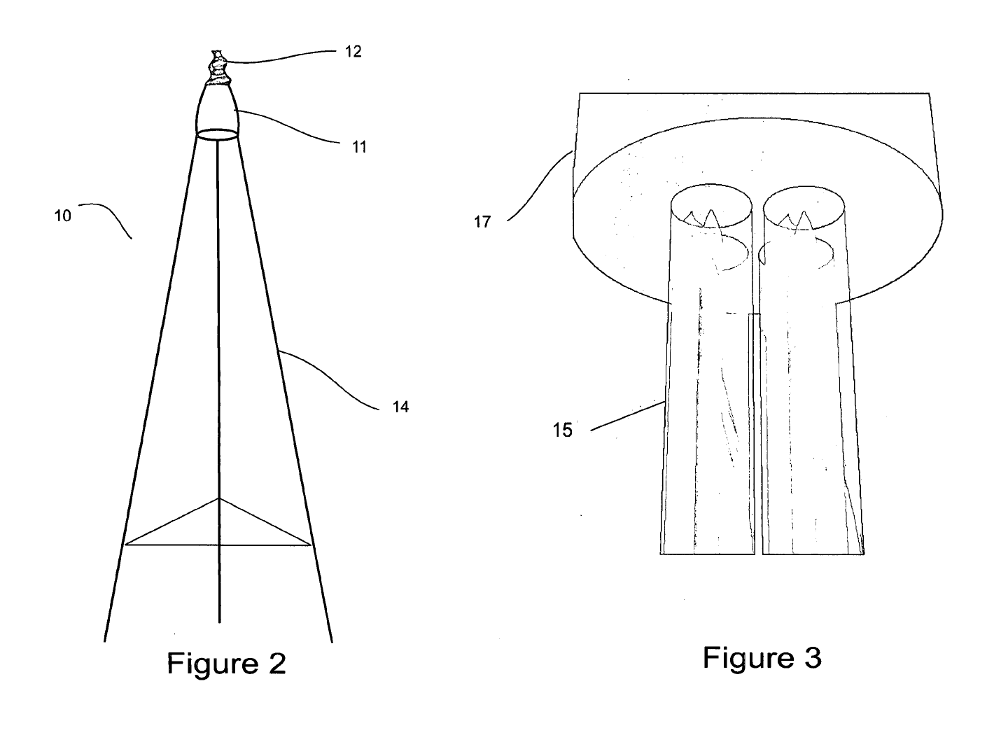

The atmospheric circulation system 1 according to the invention comprises one or more elemental vortex generating units 10. An elemental vortex generating unit 10 according to a first embodiment is illustrated in FIGS. 1 to 4. As shown in the drawings, the vortex generating unit 10 comprises a jet generating means 11, a vortex-inducing nozzle 12 and a support stand 14. The jet generating means 11 may comprise any suitable means to create a high speed jet of gas, and, in initial testing, jet engines used for commercial passenger aircraft have been found to be the most cost-effective means during the initial development and trials, as second hand engines may be obtained relatively cheaply. Nevertheless, it is to be appreciated that other jet emitting devices can be suitable, including but not limited to rocket engines. Initial testing suggests that each of these has advantages for certain applications.

Throughout the remainder of this specification, the jet emitting device is referred to as a jet engine, but this reference is not intended to limit the jet engine to any particular form of a jet emitting means.

The vortex inducing nozzle 12 comprises a tubular body wherein the cross-sectional area decreases progressively between the inlet and the outlet. In addition, the interior of the nozzle comprises formations configured to cause the gas travelling through the nozzle from inlet to outlet to be given a rotational component of speed relative to the axis of the nozzle. As a result, the gas emitted from the nozzle is caused to rotate or spin at a significant rate relative to the longitudinal velocity. The output of the nozzle is directed vertically upwards and as a result an upwardly directed, spinning flow stream is established.

The disclosure of Jayden David Harman, WO 2005/003616 (also published as US 20060102239 and others) discloses several embodiments of a fluid flow nozzle adapted to cause the fluid to flow through the nozzle in a vortical manner. In particular, it is noted that optimum efficiency will be achieved where the active surface of the nozzle is configured to conform to the Golden Section. It is believed that optimum efficiency for the present invention is also obtained where the nozzle 12 is designed in accordance with the principles disclosed in WO 2005/003616. Therefore, the disclosure WO 2005/003616 is hereby incorporated by reference. Nevertheless, the present invention is not restricted to use of nozzles conforming to the configurations disclosed in that reference.

The inlet of nozzle 12 is associated with the outlet of the jet engine 11. Jet engines of commercial jet aircraft include a standard nozzle and the nozzle 12 of the present invention replaces the standard nozzle. An adapter means (not shown) is provided to connect the nozzle 12 with the jet engine 11. The adapter means may be a separate component or may be integral with the inlet of the nozzle 12. It is envisaged that jet engines designed for the application may have the nozzle 12 integral with the body of the jet engine 11.

The jet engine-nozzle assembly is supported by a support stand. In its simplest form, the support stand 14 is designed to support the jet engine-nozzle assembly above the ground level in a vertical orientation with the output of the nozzle directed upwards. While it is desirable to have the engine as a far above the ground as practical, it is considered that a height of 30 metres is satisfactory and even less than this can be acceptable. For a fixed installation, the design of the support stand is a straight forward structural engineering problem which will depend upon the site selected. As an alternative, it can be possible to locate the engine much closer to the ground if the engine inlet is provided with a suitable inlet cowling that enables air to be drawn in to the engine without excessive turbulence or hindrance.

While the erection of a fixed stand is considered a straightforward matter, the engine-nozzle assembly may also be arranged on a transportable platform such as a trailer pulled by a prime mover. While there are some technical difficulties to be overcome, it is not believed that these would be insuperable. A mobile apparatus would enable the apparatus to be operated at a variety of locations as required. This may be particularly useful for tornado abatement, as discussed below.

A single vortex generating unit 10 of the first embodiment produces an atmospheric vortex that may be likened to a whirlwind or dust devil. This is not sufficient to have any significant atmospheric effect. However, it is known that when two vortex streams which are rotating in the same direction are adjacent, they will tend to join together with very little loss of energy and form a single vortex stream of combined strength. As shown in FIG. 3, the vortex streams 15 of an array of elemental vortex generating units 10 are combined to provide a single, powerful vortex stream 17 the array thereby providing a vortex generating cluster. A single jet engine for a commercial aircraft can have an output in the order of 50 megawatts. Therefore, an array of 10 units will have a combined output in the order of 500 megawatts, which Michaud suggests is the power required to form a man-made tornado of sufficient strength to influence the atmosphere. This is further illustrated in FIG. 12. In a further enhancement of power, a plurality of clusters of units may be combined to create an even more powerful vortex.

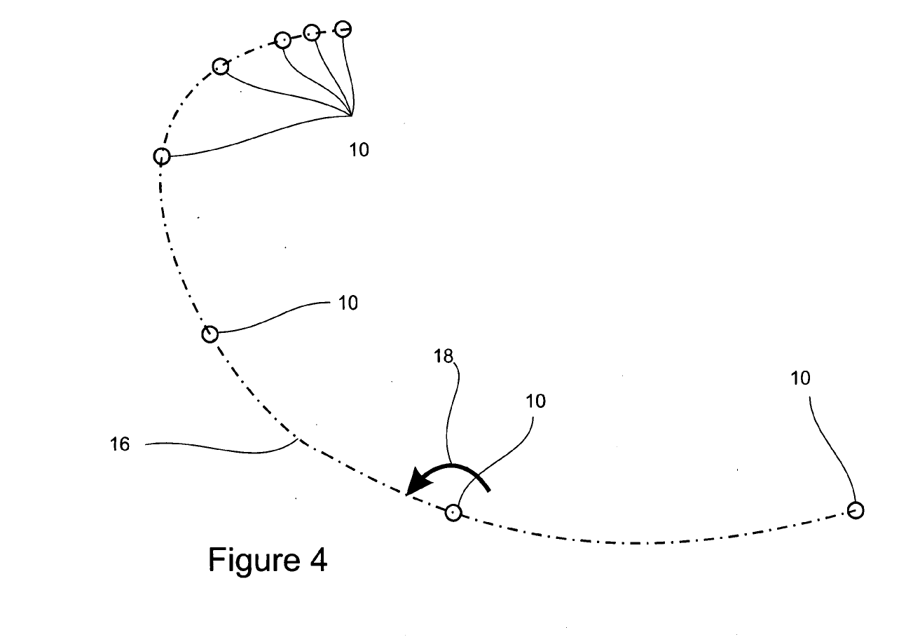

While it is believed that many arrangements for the array will be functional and that the place at which the atmospheric circulation system is located will have a bearing on the layout that is selected of a particular cluster, it is believed that a layout where each vortex generating unit 10 is placed along the locus 16 of an equiangular logarithmic spiral winding in the same direction of rotation as the direction of rotation illustrated in FIG. 12. This layout accords with natural fluid flow tendencies and assists the vortex streams to combine. Optimally, the units are spaced at intervals that are in accordance with the Fibonacci sequence. An example of this is shown in FIG. 4 where the spacing ratios are 1:1:2:3:5:8:13.

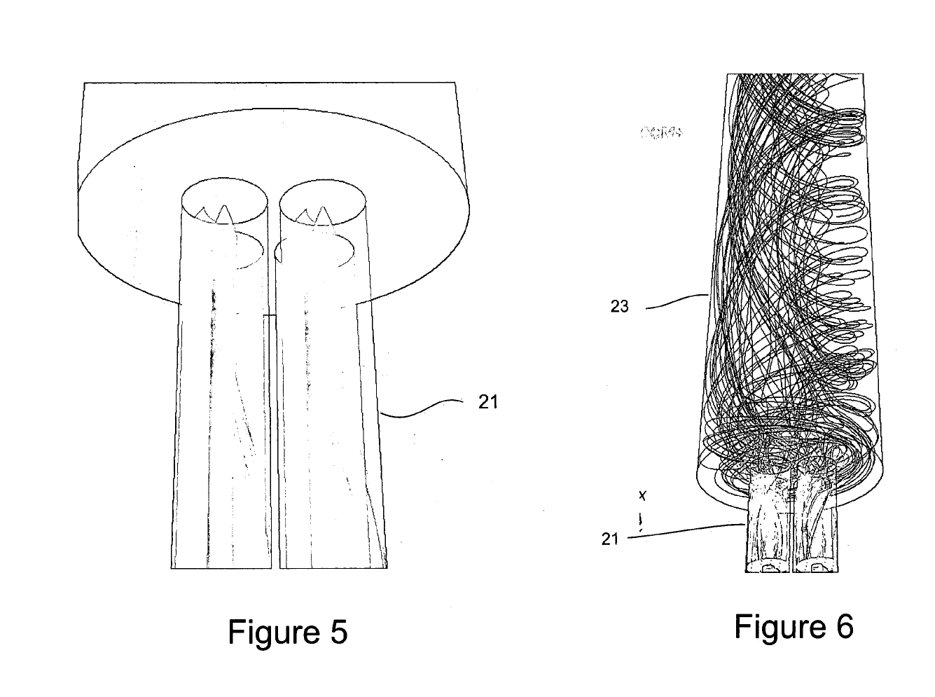

FIGS. 5 and 6 illustrate a second embodiment of a group of vortex generating units. In this embodiment, swirl inducing devices are placed in the flow streams 21 exiting from the jet engines to induce rotation in the flow. The flow is the combined locally to create a single vortex 23, as is shown in FIG. 6.

A third embodiment of a vortex generating unit according to the invention comprises a fan or propeller driven by an appropriate motor. While a specific engine may be designed for the application, in initial testing and development an engine for a turboprop aeroplane has been found to be suitable. Preferably the fan is designed to provide both axial flow and rotation of the air flow relative to axis so that in this embodiment, no nozzle is required to cause the vortex flow. The patents of Jayden David Harman, U.S. Pat. No. 5,934,877 and U.S. Pat. No. 7,488,151 give guidance as to the principles required to optimize the design of the rotor to produce such an air flow. The disclosure of these patents is hereby incorporated by reference. The vortex generating unit according to the second embodiment may be operated in conjunction with other units to provide clusters in the same manner as for the first embodiment to thereby provide a single, high-powered atmospheric vortex.

A vortex generating unit according to the third embodiment has potential to be more efficient than that of the first embodiment due to the operating characteristics of a fan or propeller at the speeds being contemplated. However, for a practical system, it is believed that it will be desirable to provide a unit capable of operating at power levels comparable with that of large turbofan jet engines, i.e. in the order of 50 megawatts. The unit would require development of a fan capable of handling this level, and initial design studies have shown that such a fan is quite feasible and indeed and be of quite modest size relative to the power being contemplated.

However, the practical difficulty would lie in powering such a fan. The largest turboprop engines have a power less than one tenth of this amount. It may be possible to use power sources other than a jet engine, but alternatives have their own difficulties. For instance, a 50 MW electric motor is conceivable, but powering a cluster of ten or more units is not. It is understood that high power turboprop jet engines are at least being studied and implementation of the third embodiment may need to await their development.

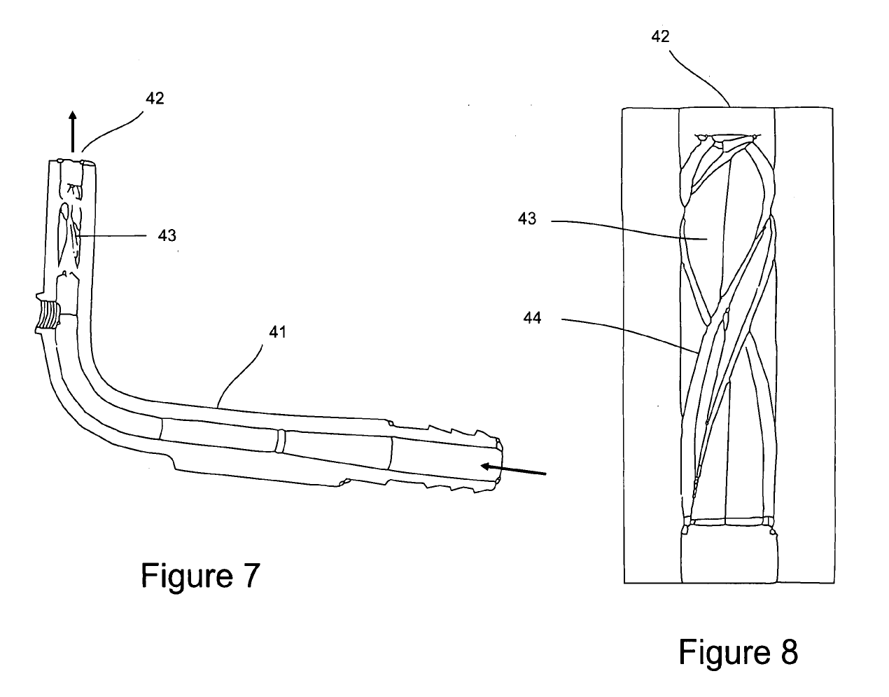

The first and second embodiments have been directed to a jet engine incorporating a suitable nozzle on the outlet while the third describes an engine driving a propeller. A fourth embodiment of the jet generating means according to the invention is described with reference to FIGS. 7 and 8. In this embodiment, the jet generating means comprises a duct 41 through which gas is passed and ejected at an outlet 42. A nozzle insert 43 is located within the duct 41 proximate the outlet 42. As shown in FIG. 8, the insert 43 has one or more vanes 44 having a spiralling-helical form of varied pitch to accelerate airflow flow through it into a vortical-like motion. Examples of suitable inserts have previously been described with reference to an earlier disclosure WO 2003/056228 which is hereby incorporated by reference. As shown in FIG. 7, air is provided to the insert through the duct by compressor means. The compressor means could be a single large compressor such as a jet engine, or alternatively, be supplied by a plurality of small compressors either directly through a manifold or via a large pressure vessel in which compressed gas is stored in advance. The gas may be air or another gas, or a mixture of air and another gas or gases.

It can be seen that atmospheric circulation system described creates a small man-made tornado. When produced in the way described, such a vortex can be employed with great benefit in a number of ways.

### a) DESTRUCTION OF INVERSION LAYER

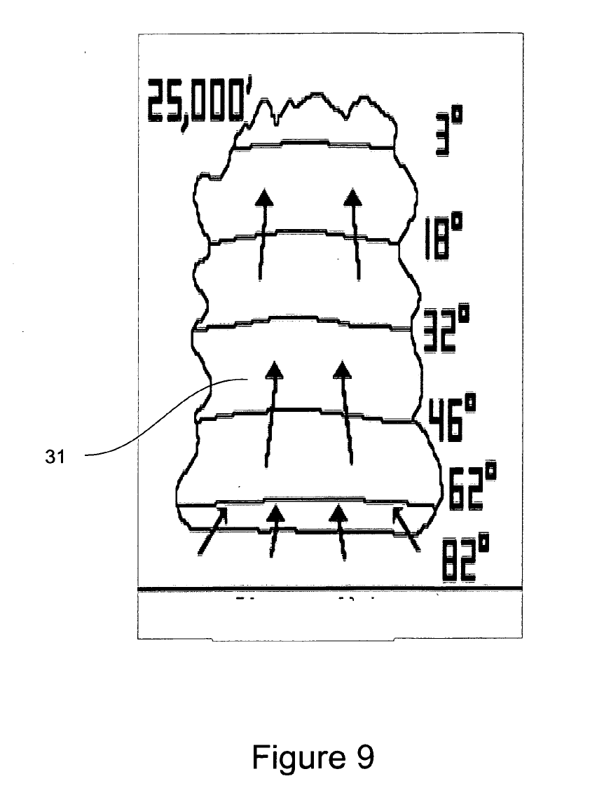

Inversion layers in the atmosphere can be a major cause of health problems in heavily populated cities such as Los Angeles, Beijing, Mexico City and Mumbai. In general, thermal layers occur because a warmer layer of air moves over a cooler layer. Such inversions prevent the circulation of the lower atmosphere to the upper atmosphere. In the process, pollutants are “trapped” within the lower level and can build to a level which is dangerous to health. A man-mad vortex in the atmosphere can act as a chimney funnelling the vortex flow well into the upper air layer, thereby breaking the inversion. The build up of pollutants can thereby be reduced considerably. FIG. 9 indicates the creation of an artificial vortex flow which would be effective at destabilizing typical inversion layers.

### b) RAIN MAKING

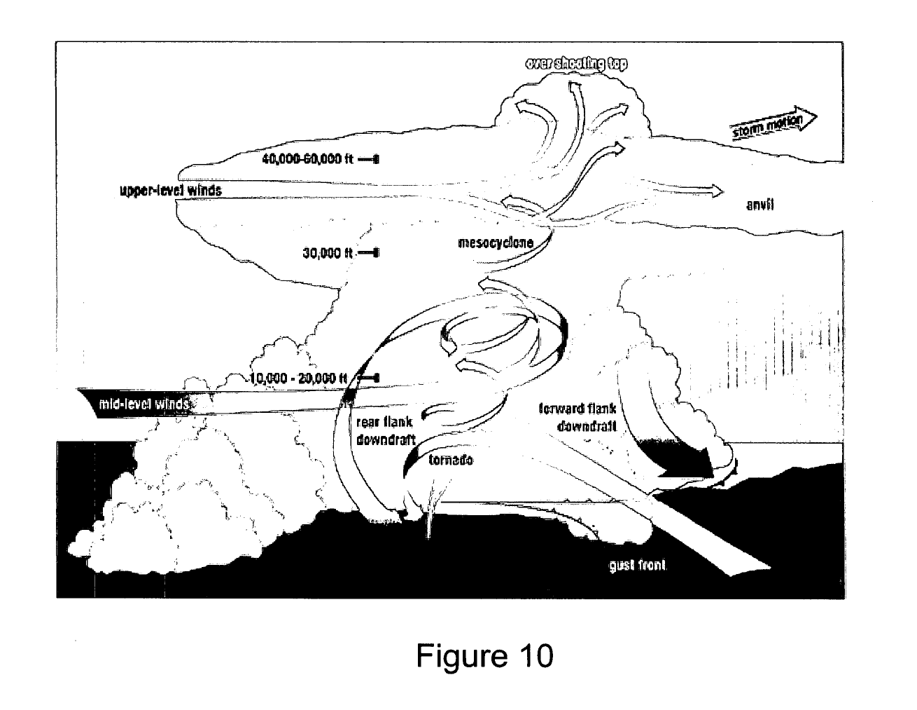

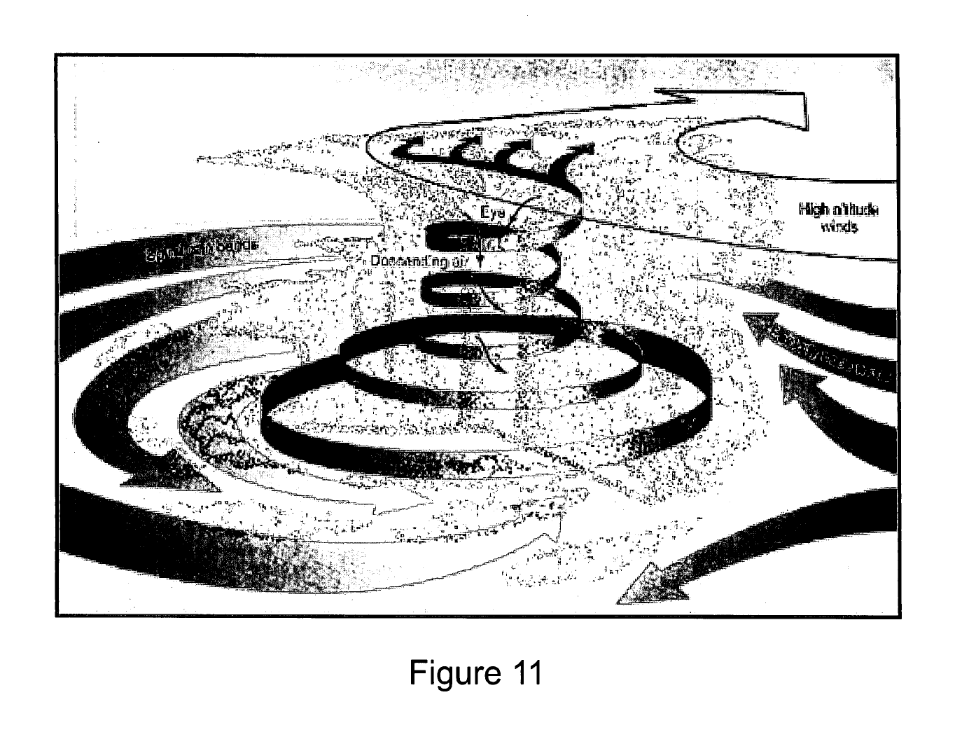

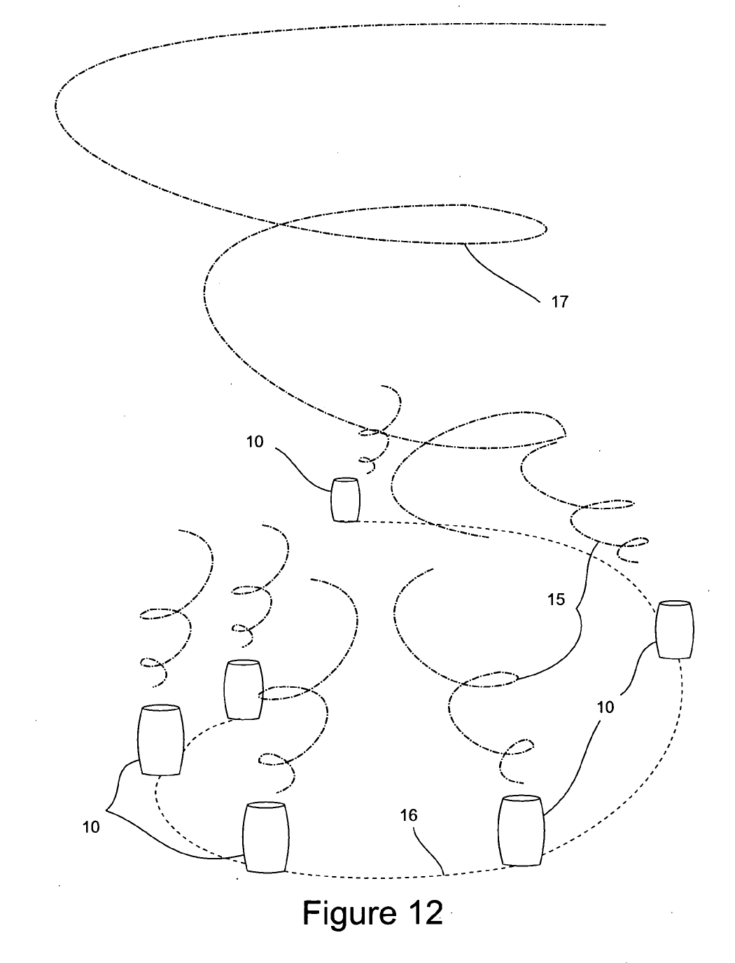

There are many places on the earth which have high humidity but low rainfall due to lack of suitable geographical features that might cause the moist air to rise and thereby produce rain. An artificial vortex provided in such places can cause rainfall to be initiated, as warm, moist air is caused to flow rapidly up to a high altitude, cooling it and resulting in precipitation. This particular outcome can be enhanced if the jet engine is fuelled by hydrogen. Then, depending on the purity of the hydrogen, all or substantially all of the exhaust gas of the combustion is heated water vapour which will tend to nucleate the existing atmospheric water vapour to promote precipitation when the vortex reaches a high altitude. FIG. 10 illustrates the flow stream that would be typical in a rain-making use. In the event that a jet generating means according to the fourth embodiment is utilized, the other gas in a mixture may be water vapour in high concentration to cause a similar result.

### c) TORNADO ABATEMENT

Tornados can cause very major damage. In certain areas of USA and some other countries they are quite common at certain times of the year. Tornados rotate cyclonically in direction (counterclockwise in the northern hemisphere, clockwise in the southern hemisphere) and it has been suggested that by generating a vortex in the opposite direction of rotation, a tornado might be stopped. It is doubtful that such an effect would be possible due to the differences in power between a real tornado and an artificial vortex. Nevertheless, it is believed that generation of the artificial vortex in advance of the storm build up may be effective at dissipating the storm before it has built to a stage where a tornado might form. By creating a vortex that is counter-rotating, it is assured that an element of control is introduced. When motivating energy for the artificial vortex is stopped, the vortex will stop.

For this application, it will be appreciated that mobility of the atmospheric circulation system will be essential to allow the vortex to be produced in the optimal location, at relatively short notice.

At a broader level, by setting up the system for anti-cyclonic rotation, it is believed that the system can be used to provide control or at least ameliorate the effects of serious storms generally. By cancelling out the storm energy early, the storm can be carried away and diffused.

### d) DEFLECTING HURRICANES

Atmospheric researchers have shown by computer modelling that the path travelled by a hurricane can be altered by a quite small atmospheric effect. It is believed that the atmospheric circulation system of the present invention can be an effective means of causing such deflection.

### e) HEAT EXPULSION

World leaders now acknowledge that Global warming is in progress, with the average temperature at the Earth's surface rising. While the process is complex, the crux of the problem is that increased levels of carbon dioxide and water vapour are trapping heat within the atmosphere. FIG. 1 illustrates the flow system that would be effective to transport heat to the upper atmosphere where it will more readily dissipate into space. In order to it is believed that it would be necessary to a plurality of large clusters or clusters of clusters at selected locations around the earth. While such an undertaking would be very expensive, it is believed that the cost would be minor compared with the impact of Global Warming. At an international level, countries could be required to operate systems in proportion to the extent of greenhouse gasses they emit. This would be a much simpler and more effective obligation than contentious steps that are presently being proposed such as carbon credits/trading, etc. Operated in the vicinity of glaciers, the system may provide sufficient cooling to prevent further melting of glacier system that are threatened as part of global warming.

The above embodiments identify but a few of the potential applications to which the invention may be adapted. It should be appreciated that the scope of the present invention need not be limited to the particular scope of the embodiments described above.

What is claimed is:

1. An artificially created atmospheric circulation system comprising a plurality of vortex generating units, wherein each vortex generating unit is configured to generate an upwardly directed vortex within the atmosphere and wherein the plurality of vortex generating units are configured and associated so that all of the vortices produced combine to provide a single atmospheric vortex.

2. An atmospheric circulation system as claimed at claim 1 wherein each vortex generating unit comprises a jet emitting means and a nozzle, the jet emitting means being adapted to accelerate atmospheric gas into a gas jet and the nozzle being adapted to cause rotation of the gas jet relative to the axis of the nozzle.

3. An atmospheric circulation system as claimed at claim 2 wherein the jet emitting means and nozzle are supported by a support stand at a suitable distance above the surface of the ground to enable air to be drawn into the jet emitting means without significant impairment and the output of the nozzle is directed substantially vertically.

4. An atmospheric circulation system as claimed at claim 2 wherein the jet emitting means comprises a jet engine suitable for an aircraft.

5. An atmospheric circulation system as claimed at claim 2 wherein the jet emitting means is fuelled substantially by hydrogen so that the combustion products promote the formation of precipitation.

6. An atmospheric circulation system as claimed at claim 1 wherein each vortex generating unit comprises a fan driven by a motor, wherein the fan is configured to generate an atmospheric vortex.

7. An atmospheric circulation system as claimed at claim 1 wherein each vortex generating unit comprises a duct through which gas is passed and ejected at an outlet, the duct having an insert proximate the outlet, wherein the insert has one or more vanes having a spiralling-helical form of varied pitch to accelerate airflow flow through it into a vortical-like motion to thereby generate an atmospheric vortex.

8. A method of disrupting an inversion layer in the atmosphere by use of an atmospheric circulation system as claimed in claim 1.

9. A method of causing the precipitation of rain by the use of an atmospheric circulation system as claimed in claim 1.

10. A method of causing the abatement of tornados or storms by the use of an atmospheric circulation system as claimed in claim 1.

11. A method for deflecting the course of a hurricane, cyclone, typhoon or the like by the use of an atmospheric circulation system as claimed in claim 1.

12. A method of expelling heat from the lower atmosphere of the earth by use of an atmospheric circulation system as claimed in claim 1.
